(19) United States
(12) Patent Application Publication
(10) Pub. No.: US 2012/0148804 A1
(43) Pub. Date: Jun. 14, 2012

(54) MULTILAYER PANEL

(75) Inventor: Elena Dodi, Nerviano (MI) (IT)

(73) Assignee: Arche Pannelli S.r.l., Nerviano (MI) (IT)

(21) Appl. No.: 13/391,232

(22) PCT Filed: Aug. 12, 2010
(86) PCT No.: PCT/EP2010/061751

§ 371 Date: Feb. 17, 2012

(30) Foreign Application Priority Data
Aug. 18, 2009 (IT) MI2009A001490

(51) Int. Cl. B32B 27/08; B32B 3/10; B32B 27/40; B32B 27/36; B32B 27/32; B32B 15/20

(52) U.S. Cl. 428/188; 428/521; 428/457; 428/423.1; 428/480; 428/195.1; 428/424.8; 428/441; 428/507; 428/519; 428/319.3; 428/213

(57) ABSTRACT

A multilayer panel that comprises: a first layer in view, which has an aesthetic function, is resistant, and is made of PDCPD; a second, insulation and self-bonding, layer of polyurethane; and possibly a third, flexible or semi-rigid, layer, formed by a plastic or metal film with the function of vapour barrier, which can be made of PU or PE film.

The present invention relates to a multilayer panel comprising an insulation layer with low permeability to water vapour and a structural layer made of polydicyclopentadiene.

Structures formed by plane or curved plates or panels associated to thermoacoustic-insulation elements have been known for many years, particularly in the building sector. Such structures are generally formed by two outer sheets of metal, in particular steel, aluminium, copper, zinc-titanium, between which is set a plastic insulation material, mainly rigid or expanded polyurethane, or other insulation material such as rock wool. The outer metal sheets, that can have a planar or curved shape, are typically formed with the outer surface ribbed, or slatted, or fretted in order to provide the required mechanical resistance.

A drawback of said structures is that the presence of two external metal sheets creates thermal bridges along the continuous surfaces and around the areas of contact of the sheets. A further disadvantage of a multilayer panel described above is its sensitivity to high and to low temperatures. In both cases the effect produced is a delamination, i.e., a detachment of the insulation layer set between and the outer metal sheets that constitute the outer walls of the panel. Delamination causes in turn a loss of adhesion and possible infiltration of water or vapour within the panel, with subsequent reduction in the insulation properties and formation of moulds and bacteria.

Also known are plane structures formed by two layers of aluminium with a thin layer of polyethylene in-between, particularly suitable to architectural applications. Said structures, however, do not provide a good insulation and cannot be manufactured in a simple process.

Also known are structures that comprise a layer of thermoformed plastic material and a layer of insulation material, in which the layer of thermoformed plastic provides rigidity to the structure with respect to bending, impact, and the force of the wind. These structures are normally formed by extruded polymers and have the drawback of a large thickness of the plate and hence a heavy weight, with consequent difficulty of assembly.

EP1095762 A1 describes a panel designed for a specific application in the automotive industry, particularly for the roof of an industrial vehicle. The panel consists of two outer layers with an insulation foam or a honeycomb structure in-between. The outer layers can be made of polydicyclopentadiene. This panel has a considerable cost for several reasons. First of all it is made as a cup-shaped single-piece element that requires the presence of two layers of polydicyclopentadiene. The special shape as roof of a truck includes parts in which the two layers are not parallel and/or parts with irregular shape. The cost can be further increased if the insulation layer is a honeycomb structure. Also, no disclosure is made with respect to the water vapour permeability of the insulation foam.

It would be desirable to have a multilayer panel of simple and light structure, good outer appearance, good resistance to water permeability to be used for a variety of applications.

An object of the present invention is thus a panel with suitable properties for use in the building sector, for coating facades, ceilings, prefabricated structures, finish elements for exteriors and interiors, balconies, stairways, attics, etc., or to be used in other sectors, for example for coating apparatuses that require thermal insulation, such as refrigerators, where said panel has good characteristics of resistance and a contained weight so that it can be handled conveniently, is not subject to phenomena of wear, can be shaped as desired at a reasonable cost.

Another object of the present invention is a panel suitable to be connected to other panels of the same of different type to form to form walls, partitions or prefabricated structures as said above.

The above and other objects and advantages of the invention, as will appear from the following description, are achieved with a multilayer panel, characterized in that it comprises an insulation layer with low permeability to water vapour and a layer made of polydicyclopentadiene.

Polydicyclopentadiene (PDCPD) is a thermosetting polymer obtained via ring-opening metathesis polymerization (ROMP) starting from the monomer dicyclopentadiene. This thermosetting material cannot be moulded; hence pieces are made already of the desired shape prior to hardening through a process of reaction injection-moulding (RIM), which envisages injection, within a mould of the desired shape, of the dicyclopentadiene monomer and of the catalyst. Polymerization and formation of the finished article hence occur within the mould.

PDCPD bestows upon the structure stiffness, mechanical resistance to impact, chemical resistance (to acids, bases, saline environment), impermeability to water, lightness, thermal insulation, acoustic insulation, electrical insulation, high shapeability.

On account of its dielectric character, PDCPD does not present particular earthing problems or problems of electrical bridges with the supporting structures or with the fixing means. Likewise, it does not require any passivation even over time. Furthermore, it can be re-painted, re-ennobled, washed in situ, and can be restructured and reused as new plate for panels once disassembled and separated from the insulation.

Some characteristics of polydicyclopentadiene are listed in Table 1.

TABLE 1

| Properties | ASTM Method | PDCPD |
|---|---|---|
| Density, g/cc | D792 | 1.03 |
| Absorption of water in 24 hours (%) | D570 | 0.12 |
| Tensile strength, 5% strain (MPa) | D638 | 6.08 |
| Tensile modulus (GPa) | D638 | 1.90 |
| Resistance to bending (MPa) | D790 | 70 |
| Bending modulus (GPa) | D790 | 1.88 |
| Yielding load (%) | D638 | 4.07 |

According to the invention, the layer of insulation material has a low permeability to water vapour and acts as thermal and/or acoustic insulator. It can be constituted by a possibly expanded synthetic resin, such as polyurethane or expanded or non-expanded polyisocyanurate, by panels made of polyurethane, polyisocyanurate, extruded polystyrene, expanded polystyrene, or else can be constituted by mineral wool, fibre glass, natural wool, cotton fibres, coconut fibres, linen fibres, and other materials ensuring thermal or acoustic insulation, appropriately compacted and glued. Said layer, in addition to bestowing thermoacoustic insulation, can also favour stiffness of the structure when the outer layer is at the minimum thickness.

By the term “low permeability to water vapour” is meant the property of resistance to the passage of water vapour according to the DIN 4108 standard, defined as coefficient μ.

The water vapour diffusion resistance factor μ is obtained by dividing the water vapour diffusion coefficient in air δₐᵢᵣ by the moisture permeability of a given material δₘₐₜ.

μ=δₐᵢᵣ/δₘₐₜ

The water vapour resistance factor, commonly called μ-factor, is therefore a dimensionless number describing how many times better a material or product is at resisting the passage of water vapour, compared with an equivalent thickness of air. Thus high μ-factor mean high resistance to water vapour transmission. Therefore, the lower is the μ-factor the thicker is the insulation material required to achieve the same reduction of diffusion δ.

According to the present invention, the multilayer panel comprises an insulation layer with μ≧50, preferably μ≧100, even more preferably μ≧1000, and preferably ≦10000.

Values of the coefficient μ for some materials are provided in Table 2.

TABLE 2

| | Density | Coefficient of resistance |
|---|---|---|
| Material | kg/m³ | to passage of vapour |
| Foamed materials: | | |
| Polystyrene | 10 | 10-50 |
| | 20 | 40-100 |
| | 40 | 80-210 |
| Polyurethane | 38 | 50-10000 |
| Tarred felt cardboard | 500 g/m² | 3640-18280 |
| Polyvinyl-chloride sheet | 25 g/m² | 50 000 |
| Tar coating | — | 80 000 |
| Coated tarred felt cardboard | 1500-2000 g/m² | 80 000 |
| Polyethylene sheet | — | 100 000 |
| Aluminium sheet | ≧125 g/m² | practically infinite |

In the case where the insulation layer is made of polyurethane or polyisocyanurate, there can be added thereto or incorporated therein materials that have insulation characteristics, such as mineral fibres, natural fibres, wood chips, residue of processing or manufacture of cottons and wools, felt, cork, pressed sawdust, polyurethane scraps or polyurethane from recycling. Said materials improve the characteristics thereof both as regards thermal insulation and in terms of acoustic insulation.

In the case where the insulation material is not expanded polyurethane or polyisocyanurate but one of those referred to previously, it may be necessary to use an appropriate adhesive or gluing process to fix said insulation layer to the PDCPD plate.

In an other embodiment of a panel according to the present invention, the insulation layer comprises an aerogel.

Aerogel is a manufactured material with the lowest bulk density of any known porous solid. It is derived from a gel in which the liquid component of the gel has been replaced with a gas. The result is an extremely low-density solid with several remarkable properties, most notably its effectiveness as a thermal insulator. The most common type of aerogel is silica aerogel, but other types can be carbon aerogel, alumina aerogels, made with aluminium oxide and SEAgel, made of agar.

According to the present invention, if d₁ is the thickness of PDCPD layer and d₂ is the thickness of the insulation layer, in a preferred embodiment d₁<d₂. The thickness d₁ is preferably from 1 mm to 10 mm, more preferably from 2 mm to 8 mm, most preferably from 3 mm to 5 mm. The thickness d₂ is preferably from 5 mm to 250 mm, more preferably from 8 mm to 200 mm, most preferably from 10 mm to 150 mm.

According to the present invention, it has been found that a permeability to water vapour ≧50 prevents substantial flow of water from reaching the interface PDCPD-insulation layer and cause delamination and possible separation of the two layers. This is particularly important since in many applications the multilayer panel according to the invention is a repeating module within a larger structure, which requires assembling several panels to each other through junction points or lines to form continuous surfaces. If water vapour transmission to the interface PDCPD-insulation layer is not substantially prevented such junction points or lines can be attacked by moisture.

The characteristics of low permeability to water vapour peculiar to the insulation layer as referred to previously, can be improved through the application of a third layer, which confers upon the structure the desired characteristics. Such third layer is applied to the side of the insulation layer opposed to the layer of PDCPD. In the case where the insulation layer possesses the required low permeability to water vapour, said third layer may not be present, since it is the insulating layer itself that forms a thin “film” having the very functions of vapour barrier.

Said third layer, when present, is flexible or semirigid and is constituted by a plastic or metal film such as PU, PE, aluminium, tarred felt cardboard, polyvinyl-chloride sheet.

An outer finishing film can be applied on the polycyclopentadiene layer, or else either a digital printing or a multilayer printing, or else painting can be carried out, even under the press during moulding of the PDCPD, also with the aim of obtaining particular aesthetic characteristics.

An illustrative and non-limiting example of the process of formation of the panel according to the present invention will now be briefly described, where the insulation layer is made of polyurethane and the film having the function of vapour barrier is made of polyethylene.
a) Formation of the PDCPD plate.
The mould of the desired shape is pre-heated by contact with the surfaces of the moulding press used.
In the case where the plate envisages an outer finishing achieved by application of a film, this is deposited on the bottom part of the mould, cut to the required size and adequately fixed. Then, the film undergoes cold-plasma treatment on the inner side to ensure cleanliness thereof.
The press is closed; the components then undergo the process of injection necessary to bring about the reaction of polymerization (DCPD+catalyst).
The plate thus formed is stored for a period of not less than 4 hours before proceeding to the subsequent step of deposition of the insulation layer.
b) Formation of the insulation layer of polyurethane, and deposition of a polyethylene film with the function of additional vapour barrier.
The PDCPD plate previously formed is set on the bottom part of the mould, with care being taken to set the part that remains in view facing downwards.
The mould is heated until the temperature necessary to bring about polymerization is reached.
The PDCPD plate undergoes cold-plasma treatment on the inner side to ensure cleanliness thereof and homogeneity of adhesion of the insulation material.
The polyurethane is injected with the mould open.
The polyethylene film is laid on the polyurethane prior to closing of the top part of the mould.
The mould is then closed and kept closed until polymerization occurs.

The invention will now be described with reference to the attached drawings, which are provided purely by way of illustrative and non-limiting example and in which:

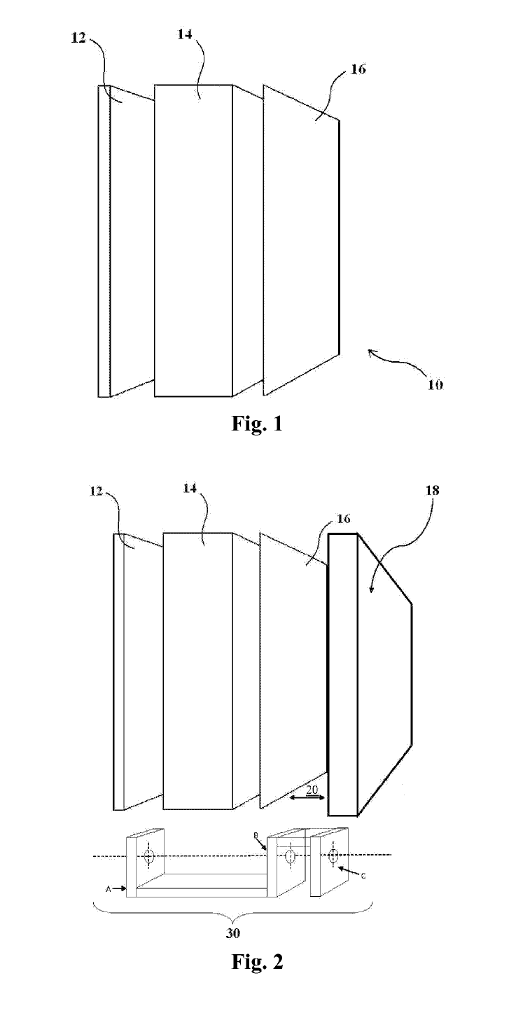

FIG. 1 illustrates a multilayer panel; and

FIG. 2 illustrates a multilayer panel provided with a ventilated room.

With reference to the annexed figures, the multilayer panel according to the present invention, designated as a whole by the reference number (10), comprises: a first layer (12), which remains in view, has an aesthetic function, is resistant, and is made of DCPD; a second layer (14), which is an insulation and self-adherent polyurethane layer; and a third layer (16), which is flexible or semi-rigid and is formed by a plastic or metal film with the function of additional vapour barrier, which can be made of PU or PE film. The thickness d₁ of the layer 12 is less than the thickness d₂ of the layer 14. The coefficient μ of the polyurethane layer is 1500.

FIG. 2 shows a second embodiment of a multilayer panel, characterized by the presence of a ventilated room.

In said embodiment, the multilayer panel with ventilated room comprises: a first layer (12), which remains in view, has an aesthetic function, is resistant, and is made of DCPD; a second, insulation, layer (14); and a third layer (16), which is flexible or semi-rigid, and is formed by a plastic or metal film having the function of additional vapour barrier, which can be made of PU or PE film. There is then defined a gap (20) ranging from 4 to 20 mm, which is followed by a fourth insulation layer (18), for example the same as or similar to the insulation layer (16). The panel is assembled by means of a lateral bracket (30), which defines a gap (30) keeping the layers (16) and (18) at a distance apart. The bracket (30) is fixed to the structure of a building by gluing and via mechanical anchor bolts. The bracket (30) can be made of plastic or metal and is glued (see the figure):

as regards the surface A, on the external or internal part of the plate (12);

as regards the surface B, on the external part of the layer forming the vapour barrier (16); and

as regards the surface C, on the internal part of the fourth insulation layer (18).

Plates of this type are present in each fixing point of the panel.

Some examples of physical properties of PDCPD will now be provided, set in comparison with the properties of some of the most common materials used in the manufacture of multilayer panels.

Table 3 gives some values of comparison between PDCPD plates and other plate systems at the typical manufacturing thickness, in which:
1. the composite-aluminium system is formed by two thin walls of aluminium (0.5 mm), set between which is polyethylene;
2. HPL (high-pressure laminate) is a high-pressure self-supporting laminate made up of cellulose (e.g., wood) fibres pre-impregnated with thermosetting resins;
3. porcelaingres is a ceramic mix made up of clay materials, quartz sands, and feldspar materials.

TABLE 3

| | | | Composite | | | | |
|---|---|---|---|---|---|---|---|
| | | | Aluminium | | | Zinc- | |
| | | DCPD | with PE | HPL | Fibre cement | Titanium | Porcelaingres |
| Reference | mm | 3 | 4 | 8 | 12.5 | 0.6 | 8 |
| thickness | | | | | | | |
| Weight/Surface | kg/m² | 3.3 | 5.5 | 6.5 | 20 | 5 | 20 |
| with reference to | | | | | | | |
| thicknesses | | | | | | | |
| Flexural strength | N/mm² | 47 | 53 | 80 | >6.5 | 57 | 27 |
| Coefficient of | m/m ° C. | 8.8 × 10⁻⁵ | 2.4 × 10⁻⁵ | 10.5 × 10⁻⁵ | 1.3 × 10⁻⁵ | 2.2 × 10⁻⁵ | 6.7 × 10⁻⁶ |
| expansion α | | | | | | | |

| | |
|---|---|
| (polyurethane α = 7.6 × 10⁻⁵) | (polystyrene α = 7.0 × 10⁻⁵) |

As emerges from the data of the table above, the coefficient of expansion of PDCPD is very similar to the coefficient of expansion of PU, used as preferred material for the thermoacoustic insulation layer 14 according to the present invention. It has been surprisingly found that this characteristic makes the panel more resistant to certain phenomena of wear such as delamination, which prevents or reduces the detachment of the insulation layer from the structural layer of PDCPD.

PDCPD bestows upon the structure a high structural resistance, at the same time with a limited weight. This affords a highly resistant panel that is practical to use. Instead, panels made of HPL prove to be heavier and more difficult to handle, in addition to not providing adequate insulation. It should also be noted that aluminium panels are subject to phenomena of delamination on account of the difference between the coefficients of expansion, in particular where the thermal shifts are very severe over less than 8 hours (e.g., from −40° C. to +60° C., in hot-arid climates).

1. A multilayer panel (10), characterized in that it comprises an insulation layer (14) with low permeability to water vapour and a layer made of polydicyclopentadiene (12); said insulation layer (14) having a resistance to the passage of water vapour according to the DIN 4108 standard, defined as coefficient μ≧50.

2. A multilayer panel (10) according to claim 1, characterized by comprising a film (16) having characteristics of vapour barrier applied on said insulation layer (14) on the opposite side to said layer made of polydicyclopentadiene (12).

3. A multilayer panel (10) according to claim 1, characterized in that said insulation layer (14) has a coefficient μ≧100.

4. A multilayer panel (10) according to claim 1, characterized in that said insulation layer (14) has a coefficient μ≧1000.

5. A multilayer panel (10) according to claim 1, characterized in that said insulation layer (14) is made of polyurethane.

6. A multilayer panel (10) according to claim 1, characterized in that said insulation layer (14) comprises a material selected from extruded polystyrene, expanded polystyrene, sheets of fibre glass, cotton, aerogel.

7. A multilayer panel (10) according to claim 5, characterized in that it incorporates in said insulation layer (14) materials that have insulation characteristics.

8. A multilayer panel (10) according to claim 2, characterized in that said film (16) having characteristics of vapour barrier is constituted by a material selected from PU, PE, and aluminium.

9. A multilayer panel (10) according to claim 1, characterized in that said layer of polydicyclopentadiene (12) has an external finish.

10. A multilayer panel (10) according to claim 9, characterized in that said external finish comprises a film, or an external layer of paint, or a printing either digital or multilayer.

11. A multilayer panel (10) according to claim 1, characterized in that it comprises a further insulation layer (18) set at a distance from said insulation layer with low permeability to water vapour, so that a ventilated room (20) is defined between said insulation layers (14; 18).

12. A multilayer panel (10) according to claim 1, characterized in that the thickness of insulation layer (14) with low permeability to water vapour is d₂ and the thickness of said layer made of polydicyclopentadiene is d₁, said layers fulfilling the condition d₁<d₂.

13. A multilayer panel according to claim 6, characterized in that it incorporates in said insulation layer materials that have insulation characteristics.
